(19) United States
(12) Patent Application Publication
(10) Pub. No.: US 2010/0096360 A1
(43) Pub. Date: Apr. 22, 2010

(54) COMPOSITIONS AND METHODS FOR BARRIER LAYER POLISHING

(75) Inventors: You Wang, Cupertino, CA (US); Yuchun Wang, Santa Clara, CA (US); Yan Wang, Sunnyvale, CA (US); Kuo-Lih Chang, Fremont, CA (US); Jin Xu, San Jose, CA (US); Wen-Chaing Tu, Mountain View, CA (US)

Correspondence Address: PATTERSON & SHERIDAN, LLP - - APPM/TX, 3040 POST OAK BOULEVARD, SUITE 1500, HOUSTON, TX, 77056, US

(73) Assignee: APPLIED MATERIALS, INC., Santa Clara, CA (US)

(21) Appl. No.: 12/579,860

(22) Filed: Oct. 15, 2009

Related U.S. Application Data
(60) Provisional application No. 61/106,890, filed on Oct. 20, 2008.

(51) Int. Cl. C09K 13/00; C23F 1/02

(52) U.S. Cl. 216/53; 252/79.1

(57) ABSTRACT

Methods and apparatus are provided for polishing barrier layer materials. In one embodiment, a composition is provided for removing at least a barrier material from a substrate surface, including includes a base composition, a silica abrasive, a solvent, a pH between about 7 and about 10, and one or more components selected from the group of a metal passivating compound, an oxidizer, and an alumina abrasive. The composition may be used to chemical mechanical polishing process a substrate surface having a ruthenium-based barrier and one or more material selected from the group of a polysilicon layer, a dielectric layer, or metal layer.

### CROSS-REFERENCE TO RELATED APPLICATIONS

This application claims benefit of U.S. provisional patent application Ser. No. 61/106,890, filed Oct. 20, 2008, which is herein incorporated by reference

### BACKGROUND OF THE INVENTION

1. Field of the Invention

Embodiments described herein generally relate to a method for chemical mechanical polishing. In particular, embodiments described herein generally relate to a method for chemical mechanical polishing a barrier layer in a semi-conductor device.

2. Description of the Related Art

Reliably producing sub-half micron and smaller features is one of the key technologies for the next generation of very large scale integration (VLSI) and ultra large-scale integration (ULSI) of semiconductor devices. However, as the limits of circuit technology are pushed, the shrinking dimensions of interconnects in VLSI and ULSI technology have placed additional demands on processing capabilities. Reliable formation of interconnects is important to VLSI and ULSI success and to the continued effort to increase circuit density and quality of individual substrates and die.

Multilevel interconnects are formed using sequential material deposition and material removal techniques on a substrate surface to form features therein. As layers of materials are sequentially deposited and removed, the uppermost surface of the substrate may become non-planar across its surface and require planarization prior to further processing. Planarization or “polishing” is a process in which material is removed from the surface of the substrate to form a generally even, planar surface. Planarization is useful in removing excess deposited material, removing undesired surface topography, and surface defects, such as surface roughness, agglomerated materials, crystal lattice damage, scratches, and contaminated layers or materials to provide an even surface for subsequent photolithography and other semiconductor manufacturing processes.

It is extremely difficult to planarize a metal surface, particularly a copper surface, as by chemical mechanical polishing (CMP), which planarizes a layer by chemical activity as well as mechanical activity, of a damascene inlay as shown in FIGS. 1A and 1B, with a high degree of surface planarity. A damascene inlay formation process may include etching feature definitions 11 in an interlayer dielectric 10, such as a silicon oxide layer, depositing a barrier layer 13 in the feature definitions 11 and on a surface of the substrate, and depositing a thick layer of conductive material 12, such as copper, on the barrier layer 13 and substrate surface. The conductive material 12 is chemical mechanically polished to expose the barrier layer. The barrier layer is then chemical mechanically polished to remove the barrier layer to expose the interlayer dielectric 10 and filled feature definitions 11 as shown in FIG. 1A. Chemical mechanical polishing techniques to completely remove the barrier layer material often results in topographical defects, such as dishing and erosion that may affect subsequent processing of the substrate.

Dishing occurs when a portion of the surface of the inlaid metal of the interconnection formed in the feature definitions in the interlayer dielectric is excessively polished, resulting in one or more concave depressions, which may be referred to as concavities or recesses. Referring to FIG. 1A, a damascene inlay of conductive material 12 in feature definitions 11 are formed with a barrier layer 13 in a damascene feature definition 11 formed in interlayer dielectric 10, for example, silicon dioxide. Subsequent to planarization, a portion of the conductive material 12 may be depressed by an amount D, referred to as the amount of dishing. Dishing is more likely to occur in wider or less dense features on a substrate surface.

Dishing is problematic for certain materials, such as ruthenium and ruthenium alloys being used for the barrier layer in copper damascene structures. Copper and ruthenium have similar electrochemical behavior and ruthenium has lower removal rate than copper, which results in ruthenium polishing process being prone to dishing of the copper features.

Conventional planarization techniques also sometimes result in erosion, characterized by excessive polishing of the layer not targeted for removal, such as THE interlayer dielectric 10 surrounding a filled feature definition. Referring to FIG. 1B, a copper fill 21 with a barrier layer 23 formed in a dense array of feature definitions 22 are inlaid in interlayer dielectric 20. Polishing the substrate may result in loss, or erosion E, of the dielectric 20 between the copper filled feature definitions. Erosion is observed to occur near narrower or denser features formed in the substrate surface. Currently, ruthenium polishing compositions have unsatisfactory removal rates with regard to the removal rates of the dielectric material, and thus, may result in unwanted erosion of the dielectric material.

Therefore, there is a need for compositions and methods for removing barrier material from a substrate that minimizes the formation of topographical defects to the substrate during planarization.

### SUMMARY OF THE INVENTION

The present invention generally provides compositions and method for polishing barrier layer materials, including ruthenium and ruthenium alloys. In one embodiment, a composition is provided for removing at least a barrier material from a substrate surface, a metal base polishing composition having at least a solvent and from about 10 wt. % to about 15 wt. % of silica abrasive, from about 0.05 wt. % to about 0.5 wt. % of a metal passivating compound, and from about 0.05 wt. % to about 5 wt. % of an oxidizer, wherein the composition has a pH from about 7 to about 10. The composition may further include alumina abrasives.

In another aspect, a method is provided for processing a substrate, including disposing a substrate having patterned feature definitions, a ruthenium-based barrier layer disposed in the patterned feature definitions, and a metal layer disposed on the barrier layer and substrate surface in a polishing apparatus, polishing the metal layer to expose the barrier layer and polishing the ruthenium-based barrier layer using a composition including a metal base polishing composition having at least a solvent and from about 10 wt % to about 15 wt. % of silica abrasive, from about 0.05 wt. % to about 0.5 wt. % of a metal passivating compound, and from about 0.05 wt. % to about 5 wt. % of an oxidizer, wherein the composition has a pH from about 7 to about 10.

In another aspect, a method for processing a substrate including disposing a substrate having patterned feature definitions formed in a dielectric material, a ruthenium-based barrier layer disposed in the patterned feature definitions, and a polysilicon layer disposed on the barrier layer and substrate surface in a polishing apparatus, and non-selective polishing the polysilicon layer, the ruthenium-based barrier layer and dielectric layer using a composition including a conductive material base polishing composition having at least a solvent and from about 10 wt. % to about 15 wt. % of silica abrasive, from about 1 wt. % to about 8 wt. % of an alumina abrasive, and from about 0.05 wt. % to about 5 wt. % of an oxidizer, wherein the composition has a pH from about 7 to about 10.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A and 1B schematically illustrate the phenomenon of dishing and erosion respectively;

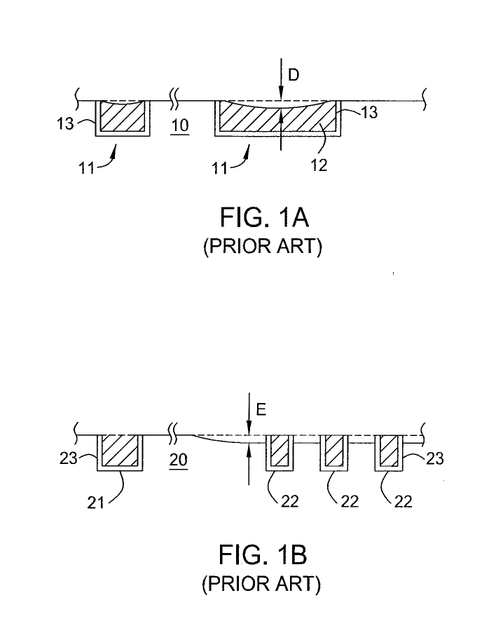

FIG. 2 is a plan view of a chemical mechanical planarizing system;

FIG. 3 is a plan view of a processing station of FIG. 2; and

FIGS. 4A-4B are schematic cross-sectional views of a DRAM structure that may be polishing with one embodiment of the composition described herein.

To facilitate understanding, identical reference numerals have been used, wherever possible, to designate identical elements that are common to the FIGS. It is contemplated that elements and/or process steps of one embodiment may be beneficially incorporated in other embodiments without additional recitation.

### DETAILED DESCRIPTION

Embodiments described herein generally provide a composition and a method for processing conductive materials disposed on a substrate in a chemical mechanical processing system. In particular, methods and compositions are provided for polishing barrier layer materials, including ruthenium and ruthenium alloys. On polishing platforms with two platens dedicated for bulk metal clearing during chemical mechanical planarization (CMP) of copper, traditionally the first platen has been used for bulk metal removal to expose the underlying barrier material and the second platen is used for barrier removal and any residual bulk metal removal. The second platen requires selective polishing to the barrier layer in order to produce uniform and low topography in terms of dishing and erosion which will lead to good line resistance (Rs) uniformity. Embodiments described herein provide an innovative process and composition that provides improved barrier selectivity compared to a metal alyer, such as copper, and providing equivalent or superior topography results in comparison with traditional methods.

Embodiments described herein will be described below in reference to a planarizing process and composition that can be carried out using chemical mechanical polishing process equipment, such as MIRRA™, MIRRA MESA™, REFLEXION™, REFLEXION LK™, and REFLEXION LK ECMP™ chemical mechanical planarizing systems, available from Applied Materials, Inc. of Santa Clara, Calif. Other planarizing modules, including those that use processing pads, planarizing webs, or a combination thereof, and those that move a substrate relative to a planarizing surface in a rotational, linear, or other planar motion may also be adapted to benefit from the embodiments described herein. In addition, any system enabling chemical mechanical polishing using the methods or compositions described herein can be used to advantage. The following apparatus description is illustrative and should not be construed or interpreted as limiting the scope of the embodiments described herein.

### One Apparatus Embodiment

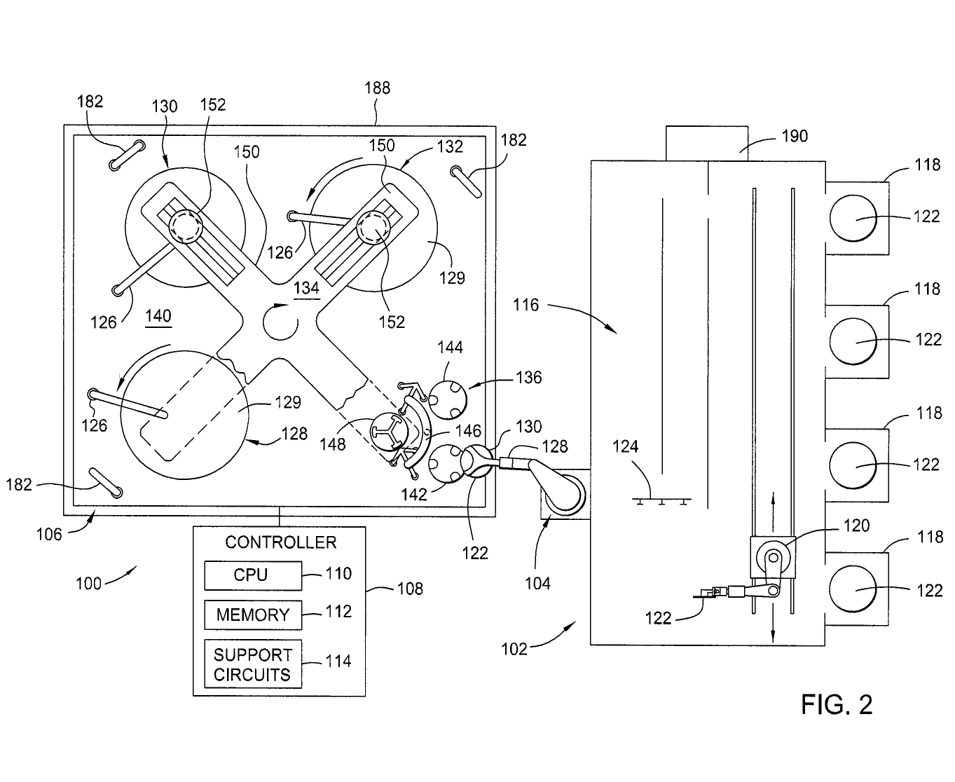

FIG. 2 is a plan view of one embodiment of a planarization system 100 having an apparatus for chemical mechanical processing of a substrate that may be adapted to benefit from the embodiments described herein. The system 100 generally comprises a factory interface 102, a loading robot 104, and a planarizing module 106. The loading robot 104 is disposed to facilitate the transfer of substrates 122 between the factory interface 102 and the planarizing module 106.

A controller 108 is provided to facilitate control and integration of the modules of the system 100. The controller 108 comprises a central processing unit (CPU) 110, a memory 112, and support circuits 114. The controller 108 is coupled to the various components of the system 100 to facilitate control of the planarizing, cleaning, and transfer processes.

The factory interface 102 generally includes a metrology module 190, a cleaning module 116 and one or more substrate cassettes 118. An interface robot 120 is employed to transfer substrates 122 between the substrate cassettes 118, the cleaning module 116, and an input module 124. The input module 124 is positioned to facilitate transfer of substrates 122 between the planarizing module 106 and the factory interface 102 by grippers, for example, vacuum grippers or mechanical clamps.

The metrology module 190 may be a non-destructive measuring device suitable for providing a metric indicative of the thickness profile of a substrate. The metrology module 190 may include eddy current sensors, an interferometer, a capacitance sensor and other suitable devices. Examples of suitable metrology modules include ISCAN™ and IMAP™ substrate metrology modules, available from Applied Materials, Inc. The metrology module 190 provides the metric to the controller 108 wherein a target removal profile is determined for the specific thickness profile measured from the substrate.

The planarizing module 106 includes at least a first planarizing station 128, such as a chemical mechanical planarizing (CMP) station 128, disposed in an environmentally controlled enclosure 188. In the embodiment depicted in FIG. 2, the planarizing module 106 includes the first planarization station 128, a second planarization station 130 and a third planarization station 132. Each of the planarization stations 128, 130, and 132 may be a chemical mechanical polishing (CMP) station. Bulk removal of conductive material disposed on the substrate 122 may be performed through a chemical mechanical polishing process at the first planarization station 128. In one embodiment, the bulk removal of conductive material may be a multi-step process. After the bulk material removal at the first planarization station 128, the remaining conductive material or residual conductive material may be removed from the substrate at the second planarization station 130 in a single-step or multi-step chemical mechanical polishing process, wherein part of the multi-step process is configured to remove residual conductive material. The third planarization station 132 may be used to polish a barrier layer. In one embodiment, both the bulk material removal and residual material removal may be performed at a single station. Alternatively, more than one CMP station may be utilized to perform the multi-step removal process after the bulk removal process performed at a different station.

The exemplary planarizing module 106 also includes a transfer station 136 and a carousel 134 that are disposed on an upper or first side of a machine base 140. In one embodiment, the transfer station 136 includes an input buffer station 142, an output buffer station 144, a transfer robot 146, and a load cup assembly 148. The input buffer station 142 receives substrates from the factory interface 102 by means of the loading robot 104. The loading robot 104 is also utilized to return polished substrates from the output buffer station 144 to the factory interface 102. The transfer robot 146 is utilized to move substrates between the buffer stations 142, 144 and the load cup assembly 148.

In one embodiment, the transfer robot 146 includes two gripper assemblies, each having pneumatic gripper fingers that hold the substrate by the substrate's edge. The transfer robot 146 may simultaneously transfer a substrate to be processed from the input buffer station 142 to the load cup assembly 148 while transferring a processed substrate from the load cup assembly 148 to the output buffer station 144.

The carousel 134 is centrally disposed over the base 140. The carousel 134 typically includes a plurality of arms 150, each supporting a carrier head assembly 152. Two of the arms 150 depicted in FIG. 2 are shown in phantom such that the transfer station 136 and a planarizing surface 129 of the first planarization station 128 may be seen. The carousel 134 is indexable such that each of the carrier head assembly 152 may be moved between the planarizing stations 128, 130, and 132 and the transfer station 136. A conditioning device 182 is disposed on the base 140 adjacent each of the planarizing stations 128, 130, and 132. The conditioning device 182 periodically conditions the planarizing material disposed in the planarization stations 128, 130, and 132 to maintain uniform planarizing results.

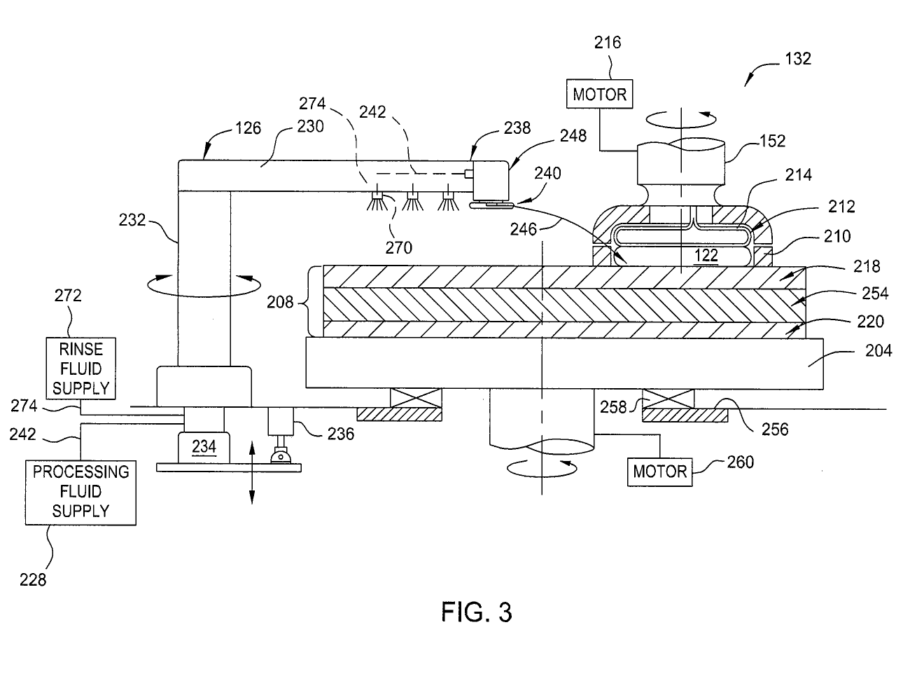

FIG. 3 is a partial sectional view of one embodiment of the first planarization station 128 that includes the fluid delivery arm assembly 126. Referring to FIG. 2, the first planarization station 128 includes the carrier head assembly 152 and a platen 204. The carrier head assembly 152 generally retains the substrate 122 against a polishing pad assembly 208 disposed on the platen 204. At least one of a carrier head assembly 152 or platen 204 is rotated or otherwise moved to provide relative motion between the substrate 122 and the polishing pad assembly 208. In the embodiment depicted in FIG. 3, the carrier head assembly 152 is coupled to an actuator or motor 216 that provides at least rotational motion to the substrate 122. The motor 216 may also oscillate the carrier head assembly 152, such that the substrate 122 is moved laterally back and forth across the surface of the polishing pad assembly 208.

The polishing pad assembly 208 may comprise a conventional material such as a foamed polymer disposed on the platen 204 as a pad. In one embodiment, the conventional polishing material is foamed polyurethane. In one embodiment, the pad is an IC1010 polyurethane pad, available from Rodel Inc., of Newark, Del. IC1010 polyurethane pads typically have a thickness of about 2.05 mm and a compressibility of about 2.01%. Other pads that can be used include IC1000 pads with and without an additional compressible bottom layer underneath the IC1000 pad, IC1010 pads with an additional compressible bottom layer underneath the IC1010 pad, and polishing pads available from other manufacturers. The compositions described herein are placed on the pad to contribute to the chemical mechanical polishing of substrate.

In one embodiment, the carrier head assembly 152 includes a retaining ring 210 circumscribing a substrate receiving pocket 212. A bladder 214 is disposed in the substrate receiving pocket 212 and may be evacuated to chuck the wafer to the carrier head assembly 152 and pressurized to control the downward force of the substrate 122 when pressed against the polishing pad assembly 208. In one embodiment, the carrier head may be a multi-zone carrier head. One suitable carrier head assembly 152 is a TITAN HEAD™ carrier head available from Applied Materials, Inc., located in Santa Clara, Calif. Other examples of carrier heads that may be adapted to benefit from the embodiments described herein are described in U.S. Pat. No. 6,159,079, issued Dec. 12, 2001, and U.S. Pat. No. 6,764,389, issued Jul. 29, 2004, which are incorporated herein by reference in their entirety.

In FIG. 3, the platen 204 is supported on a base 256 by bearings 258 that facilitate rotation of the platen 204. A motor 260 is coupled to the platen 204 and rotates the platen 204 such that the polishing pad assembly 208 is moved relative to the carrier head assembly 152.

In the embodiment depicted in FIG. 2, the polishing pad assembly 208 includes an upper layer 218 and an underlying layer 220. Optionally, one or more intervening layers 254 may be disposed between the underlying layer 220 and upper layer 218. For example, the intervening layers 254 may include at least one of a subpad and an interposed pad. In one embodiment, the subpad may be a urethane-based material, such as a foam urethane. In one embodiment, the interposed pad may be a sheet of Mylar® film.

The fluid delivery arm assembly 126 is utilized to deliver a processing fluid from a processing fluid supply 228 to a top or working surface of the conductive material forming upper layer 218. In the embodiment depicted in FIG. 3, the fluid delivery arm assembly 126 includes an arm 230 extending from a stanchion 232. A motor 234 is provided to control the rotation of the arm 230 about a center line of the stanchion 232. An adjustment mechanism 236 may be provided to control the elevation of a distal end 238 of the arm 230 relative to the working surface of the polishing pad assembly 208. The adjustment mechanism 236 may be an actuator coupled to at least one of the arm 230 or the stanchion 232 for controlling the elevation of the distal end 238 of the arm 230 relative to the platen 204. Some examples of suitable fluid delivery arms which may be adapted to benefit from the embodiments described herein are described in U.S. patent application Ser. No. 11/298,643, filed Dec. 8, 2005, entitled METHOD AND APPARATUS FOR PLANARIZING A SUBSTRATE WITH LOW FLUID CONSUMPTION; now published as US 2007/0131562, U.S. patent application Ser. No. 09/921,588, entitled MULTIPORT POLISHING FLUID DELIVERY SYSTEM, filed Aug. 2, 2001, now published as US 2003/0027505; U.S. patent application Ser. No. 10/428,914, entitled SLURRY DELIVERY ARM, filed May 2, 2003, now issued as U.S. Pat. No. 6,939,210; U.S. patent application Ser. No. 10/131,638, entitled FLEXIBLE POLISHING FLUID DELIVERY SYSTEM, filed Apr. 22, 2002, now issued as U.S. Pat. No. 7,086,933, which are all hereby incorporated by reference in their entirety to the extent not inconsistent with this application.

The fluid delivery arm assembly 126 may include a plurality of rinse outlet ports 270 arranged to uniformly deliver a spray and/or stream of rinsing fluid to the surface of the polishing pad assembly 208. The ports 270 are coupled by a tube 274 routed through the fluid delivery arm assembly 126 to a rinsing fluid supply 272. In one embodiment, the fluid delivery arm may have between 12 and 15 ports. The rinsing fluid supply 272 provides a rinsing fluid, such as deionized water, to the polishing pad assembly 208 during the polishing process and/or after the substrate 122 is removed to clean the polishing pad assembly 208. The polishing pad assembly 208 may also be cleaned using fluid from the ports 270 after conditioning the pad using a conditioning element, such as a diamond disk or brush (not shown).

The nozzle assembly 248 is disposed at the distal end of the arm 230. The nozzle assembly 248 is coupled to the fluid supply 228 by a tube 242 routed through the fluid delivery arm assembly 126. The nozzle assembly 248 includes a nozzle 240 that may be selectively adjusted relative to the arm, such that the fluid exiting the nozzle 240 may be selectively directed to a specific area of the polishing pad assembly 208.

In one embodiment, the nozzle 240 is configured to generate a spray of processing fluid. In another embodiment, the nozzle 240 is adapted to provide a stream of processing fluid. In another embodiment, the nozzle 240 is configured to provide a stream and/or spray of processing fluid 246 at a rate, for example, between about 20 to about 120 cm/second to the polishing surface.

### Polishing Composition Embodiments

Generally, the barrier chemical mechanical polishing composition includes a base composition, a silica abrasive, a solvent, a pH between about 7 and about 10, and one or more components selected from the group of a corrosion inhibitor (a metal passivating compound, an oxidizer, and an alumina abrasive.

It is believed that the barrier polishing composition described herein improve the effective removal rate of barrier materials, such as ruthenium, ruthenium-tantalum, ruthenium nitride, or combinations thereof, from the substrate surface during chemical mechanical polishing, with a reduction in planarization type defects and yielding a smoother substrate surface. Although the barrier polishing composition is particularly useful for removing ruthenium based barrier materials, and is described as follows with regard to ruthenium based barrier materials, it is believed that the barrier polishing compositions may also remove other barrier materials including tantalum and tantalum derivative materials, such as tantalum nitride, among other barrier materials.

### First Embodiment of a Barrier Polishing Composition

The first embodiment of the barrier polishing composition includes a base polishing composition, a corrosion inhibitor, an oxidizer, and a solvent, with the composition having a suitable pH level for polishing a barrier material.

The first embodiment of a barrier polishing composition provides for selective removal of barrier material to copper at a barrier removal rate to copper removal rate at from about 1.7:1 to about 2.5:1, such as about 1.75:1, with a barrier removal rate to dielectric removal rate of between about 3:1 and about 1:1, such as from about 2.7:1 to 2:1, for example about 2.1:1 for a TEOS deposited oxide layer and about 2.7:1 for a silicon oxycarbide material.

A base polishing composition for ruthenium includes the B-9003 polishing composition available from Cabot Microelectronics Corporation of Aurora, Ill.

The polishing composition may also include a corrosion inhibitor. A concentration of corrosion inhibitor from about 0.05 wt. % to about 0.5 wt. %, such as from about 0.15 wt. % to about 0.25 wt. %, for example, about 0.2 wt. %, of a corrosion inhibitor may be used in the barrier polishing composition. Suitable corrosion inhibitors include compounds having one or more azole groups. Examples of organic compounds having azole groups include benzotriazole (BTA), mercaptobenzotriazole, 5-methyl-1-benzotriazole (TTA), 1,2,4 Triazole (TRZ), and combinations thereof. Other suitable corrosion inhibitors include film forming agents that are cyclic compounds, for example, imidazole, benzimidazole, triazole, and combinations thereof. Derivatives of benzotriazole, imidazole, benzimidazole, triazole, with hydroxy, amino, imino, carboxy, mercapto, nitro and alkyl substituted groups may also be used as corrosion inhibitors. Other corrosion inhibitor includes urea and thiourea among others.

The polishing composition may also include an oxidizer. A concentration of oxidizer from about 0.05 wt. % to about 5 wt. %, such as from about 0.5 wt. % to about 2 wt. %, for example, about 1 wt. %, of the composition may be used in the polishing composition. The oxidizer may be added to the composition in a solution, such as a 30% aqueous hydrogen peroxide solution or a 40% aqueous hydrogen peroxide solution.

Examples of suitable oxidizers include peroxy compounds, e.g., compounds that may disassociate through hydroxy radicals, such as hydrogen peroxide and its adducts including urea hydrogen peroxide, percarbonates, and organic peroxides including, for example, alkyl peroxides, cyclical or aryl peroxides, benzoyl peroxide, peracetic acid, and ditertbutyl peroxide. Sulfates and sulfate derivatives, such as monopersulfates and dipersulfates may also be used including for example, ammonium peroxydisulfate, potassium peroxydisulfate, ammonium persulfate, and potassium persulfate. Salts of peroxy compounds, such as sodium percarbonate and sodium peroxide may also be used.

The oxidizer can also be an inorganic compound or a compound containing an element in its highest oxidation state. Examples of inorganic compounds and compounds containing an element in its highest oxidation state include but are not limited to periodic acid, periodate salts, perbromic acid, perbromate salts, perchloric acid, perchloric salts, perbonic acid, nitrate salts (such as cerium nitrate, iron nitrate, ammonium nitrate), ferrates, perborate salts and permanganates. Other oxidizers include bromates, chlorates, chromates, iodates, iodic acid, and cerium (IV) compounds such as ammonium cerium nitrate.

The first polishing composition may also include abrasives particles to improve the surface finish and removal rate of barrier materials from the substrate surface during polishing. Abrasive particles may comprise up to about 20 wt. % of the barrier polishing composition during processing. A concentration between about 1 wt. % and about 15 wt. % of abrasive particles may be used in the barrier polishing composition. The B-9003 polishing composition provides from about 10 wt. % to about 15 wt. % of silica as an abrasive.

Suitable abrasives particles include inorganic abrasives, for example, silica, alumina, zirconium oxide, ruthenium oxide, cerium oxide, germania, or any other abrasives of metal oxides, known or unknown. The typical abrasive particle size used in one embodiment of the current invention is generally from about 1 nm to about 1,000 nm, such as between about 30 nm and about 500 nm, for example, between about 30 nm and about 200 nm. Alternatively, the abrasives may include polymeric abrasives or be coated with a polymeric material. Examples of polymeric abrasives materials either in abrasive form or as a coating include polymethylmethacrylate, polymethyl acrylate, polystyrene, polymethacrylonitrile, and combinations thereof.

The composition may have a pH between about 7 and about 10, such as between about 8 and about 9, for example, about 8.4.

The balance or remainder of the barrier polishing composition described above is a solvent, such as a polar solvent, including water, preferably deionized water. The solvent may be included with one or more of the components as well as the base composition described herein. Other solvents may include, for example, organic solvents, such as alcohols or glycols, and in some embodiments may be combined with water. The amount of solvent may be used to control the concentrations of the various components in the barrier polishing composition. For example, the electrolyte may be concentrated up to three times as concentrated as described herein and then diluted with the solvent prior to use of diluted at the processing station as described herein.

An example of the above polishing composition is provided as follows.

### Example #1

A composition comprising:
about 98.8 wt. % of a B-9003 polishing composition including:
   between about 10 wt. % and about 15 wt. % of silica;
   and a solvent;
about 0.2 wt. % BTA; and
about 1 wt. % hydrogen peroxide, with the composition having a pH of about 8.4.

### Example #2

The substrate is transferred to a platen and a polishing composition was supplied to the platen at a rate of about 200 ml/min, and the barrier polishing composition comprising:
A composition comprising:
about 98.8 wt. % of a B-9033 polishing composition including:
   between about 10 wt. % and about 15 wt. % of silica;
   and a solvent;
about 0.2 wt. % BTA; and
about 1 wt. % hydrogen peroxide, with the composition having a pH of about 8.4.

The substrate was contacted with the polishing article at a contact pressure of about 1.5 psi, a platen rotational rate of about 87 rpm, a carrier head rotational rate of about 93 rpm and the respective removal rates were determined as shown in Table 1 below. (BD represent a silicon oxycarbide material know as Black Diamond™ dielectric material, which is commercially available from Applied Materials, Inc., of Santa Clara, Calif. The ruthenium barrier layer on the substrate surface was removed with minimal observable dishing and erosion. The first slurry in Table 1 (Ru Slurry) is a prior art slurry for ruthenium polishing.

TABLE 1

| | Removal rate at 1.5 psi | | | | |
|---|---|---|---|---|---|
| | Ru rate | TEOS rate | Cu rate | BD rate | Ru/Cu rate |
| Ru Slurry | 291 | 201 | 4958 | 188 | 0.059 |
| Ru Slurry with | 366 | 177 | 209 | 134 | 1.753 |
| inhibitor | | | | | |

### Second Composition

A second embodiment of the barrier polishing composition includes a base composition, a pH between about 7 and about 10, a solvent, a corrosion inhibitor, an oxidizer, a silica abrasive, and an alumina abrasive.

The second barrier chemical polishing composition may be used to remove non-selectively a dielectric material, a barrier material, and a bulk metal material, such as copper and tungsten. Non-selective removal is defined herein as a removal rate ratio between about 4:1 and 1:4 for any two materials to be polishing as described herein.

The second barrier polishing composition provides for barrier material and dielectric material polishing at a barrier removal rate to dielectric removal rate from about 1:4 to about 1:2, such as about 1:2.4, with a barrier removal rate to copper removal rate of between about 4:1 and about 1:1, such as about 3:1. Although the barrier polishing composition is particularly useful for removing ruthenium based materials, it is believed that the barrier polishing compositions may also remove other barrier materials including tantalum and tantalum derivative materials, such as tantalum nitride, among other barrier materials.

A base polishing composition for ruthenium polishing includes the B-9513, B-9511, and B-9003 polishing compositions available from Cabot Microelectronics Corporation of Aurora, Ill. The ruthenium base polishing composition includes a silica abrasive having a concentration from about 10 wt. % to about 15 wt. %.

The second barrier polishing composition further includes a concentration from about 1 wt. % to about 5 wt. %, such as from about 1 wt. % to about 3 wt. %, for example, about 2 wt. % of alumina abrasive. In one embodiment of the second barrier polishing composition the silica abrasive and the alumina abrasive may be at a weight percent (wt. %) ratio of silica abrasive to alumina abrasive from about 15:1 to about 2:1. The silica abrasive and alumina abrasive containing composition may also be refereed to as a dual-abrasive composition.

Additionally, both the silica and alumina abrasives may have an average size from about 50 nanometers (nm) to about 100 nanometers (nm), of which both abrasive having an average size of about 50 nanometers (nm). It has been observed that polishing rate is adversely affected if there is a difference in size of greater than 50 nanometers (nm) between the silica and alumina abrasives.

The polishing composition may also include a corrosion inhibitor. A concentration of corrosion inhibitor from about 0.05 wt. % to about 0.5 wt. %, such as from about 0.15 wt. % to about 0.25 wt. %, for example, about 0.2 wt. %, of a corrosion inhibitor may be used in the barrier polishing composition. Suitable corrosion inhibitors are those described herein with regard to the first embodiment of the barrier polishing composition.

The polishing composition may also include an oxidizer. A concentration of oxidizer from about 0.05 wt. % to about 5 wt. %, such as from about 0.5 wt. % to about 2 wt. %, for example, about 1 wt. %, of the composition may be used in the polishing composition. The oxidizer may be added to the composition in a solution, such as a 30% aqueous hydrogen peroxide solution or a 40% aqueous hydrogen peroxide solution. Suitable oxidizers are those described herein with regard to the first embodiment of the barrier polishing composition.

The composition may have a pH between about 7 and about 10, such as between about 8 and about 9, for example, a pH of about 8.5.

The balance or remainder of the barrier polishing composition described above is a solvent, such as a polar solvent, including water, preferably deionized water. Other solvents may include, for example, organic solvents, such as alcohols or glycols, and in some embodiments may be combined with water. The amount of solvent may be used to control the concentrations of the various components in the barrier polishing composition. For example, the electrolyte may be concentrated up to three times as concentrated as described herein and then diluted with the solvent prior to use of diluted at the processing station as described herein.

An example of the above polishing composition is provided as follows.

### Example #3

A composition comprising:
about 96.8 wt. % of a B-9511 polishing composition including:
   between about 10 wt. % and about 15 wt. % of silica abrasives
having an average size of 50 nm; and
   a solvent;
about 2 wt. % of alumina abrasives having an average size of 50 nm;
about 0.2 wt. % BTA; and
about 1 wt. % hydrogen peroxide, with the composition having a pH of about 8.5.

### Example #4

The substrate having barrier and copper exposed material was transferred to a platen and a polishing composition was supplied to the platen at a rate of about 300 ml/min, and the polishing composition comprising:
about 96.8 wt. % of a B-9511 polishing composition including:
   between about 10 wt. % and about 15 wt. % of silica abrasives having an average size of 50 nm; and
   a solvent;
about 2 wt. % of alumina abrasives having an average size of 50 nm;
about 0.2 wt. % BTA; and
about 1 wt. % hydrogen peroxide, with the composition having a pH of about 8.5.

The substrate was contacted with the polishing article at a contact pressure of about 0.8 or 1.5 psi, a platen rotational rate of about 103 rpm, a carrier head rotational rate of about 97 rpm. The ruthenium barrier layer was observed to have a removal rate of about 400/min and the copper layer was observed to have a removal rate of about 200 Å/min at a down force of about 1.5 psi.

The dual-abrasive compositions were compared to existing slurries and the results were as follows. The following results were generated with all processing parameters identical and all the composition components the same except for the use of the combination silica and alumina abrasive compared to the silica abrasives of the base polishing composition as shown in Table 2. The substrates that were polishing included a dielectric layer of tetraethoxysilane (TEOS) deposited material, a ruthenium barrier material, and a copper metal layer. As shown below, the dual-abrasive composition has improved copper and ruthenium rates over the prior composition having a silicon abrasive.

TABLE 2

| | Removal rate | Removal rate | Removal rate | Removal rate | Removal rate |
|---|---|---|---|---|---|
| | (Å/min) @ | (Å/min) @ | (Å/min) @ | (Å/min) @ | (Å/min) @ |
| Composition | 0.5 Psi | 0.8 Psi | 1.0 Psi | 1.5 Psi | 2.0 Psi |
| Ruthenium: B9511 | N/A | N/A | ~30 | ~50 | ~100 |
| composition | | | | | |
| Ruthenium: B9511 | ~120 | ~240 | N/A | ~450 | N/A |
| composition with | | | | | |
| dual abrasives | | | | | |
| Copper: B9511 | N/A | N/A | ~60 | ~120 | ~180 |
| composition | | | | | |
| Copper: B9511 | ~70 | ~130 | N/A | ~270 | N/A |
| composition with | | | | | |
| dual abrasives | | | | | |
| TEOS: B9511 | N/A | N/A | ~620 | ~930 | ~1190 |
| composition | | | | | |
| TEOS: B9511 | ~250 | ~500 | N/A | ~930 | N/A |
| composition with | | | | | |
| dual abrasives | | | | | |

### Third Composition

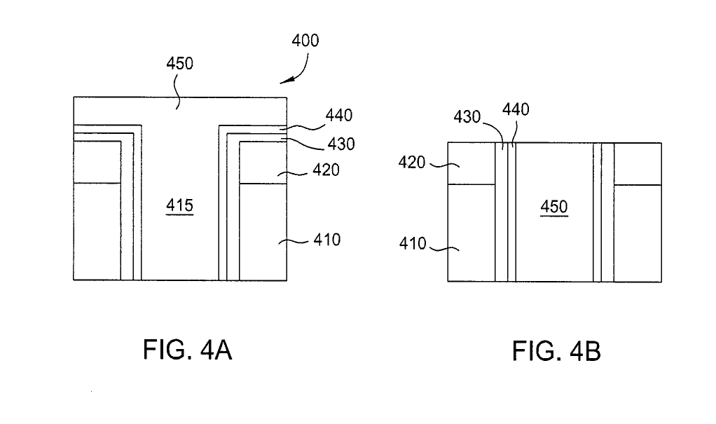

A third barrier polishing composition may provide for non-selective removal of a barrier layer, a dielectric layer, and a polysilicon layer removal. For example, such a removal process may be used for DRAM removal as shown in FIGS. 4A and 4B.

The third barrier polishing composition includes a base composition, a pH between about 7 and about 10, a solvent, a silica abrasive, and an alumina abrasive. The composition may further include an oxidizer, a corrosion inhibitor, or both.

The third barrier chemical polishing composition may be used to remove non-selectively a dielectric material, a barrier material, and a polysilicon material. Non-selective removal is defined herein as a removal rate ratio between about 4:1 and 1:4 for any two materials to be polishing as described herein. Alternatively, the third barrier chemical polishing composition may be used to remove non-selectively a dielectric material, a barrier material, and a bulk metal material, such as copper or tungsten. Similar results have been observed for when the oxide layer is replaced with a titanium or titanium nitride layer.

One embodiment of the third barrier polishing composition provides for selective removal of barrier material to dielectric material to polysilicon material at a barrier removal rate to dielectric removal rate from about 2:1 to about 1:2, such as about 1:1, with a barrier removal rate to polysilicon dielectric removal rate from about 2:1 to about 1:2, such as about 1:1. In one embodiment of the barrier material to dielectric material to polysilicon material removal rates, a barrier material to dielectric material to polysilicon material removal rate ratio is about 1:1:1.

Another embodiment of the third barrier polishing composition provides for selective removal of barrier material to dielectric material to bulk metal material, such as copper and tungsten, at a barrier removal rate to dielectric removal rate from about 2:1 to about 1:2, such as about 1:1, with a barrier removal rate to bulk metal removal rate from about 3:1 to about 5:1, for example about 4:1.

The third barrier polishing composition includes a conductive material polishing composition including the B-9513, B-9511, and B-9003 polishing compositions available from Cabot Microelectronics Corporation of Aurora, Ill. The ruthenium base polishing composition includes a silica abrasive having a concentration from about 10 wt. % to about 15 wt. %.

The third barrier polishing composition further includes a concentration from about 1 wt. % to about 8 wt. %, such as from about 3 wt. % to about 7 wt. %, for example, about 5 wt. % of alumina abrasive. In one embodiment of the third barrier polishing composition, the silica abrasive and the alumina abrasive may be at a weight percent (wt. %) ratio of silica abrasive to alumina abrasive from about 15:1 to about 1:1.

Additionally, each of the silica and alumina abrasives may have an average size from about 1 nm to about 1,000 nm, such as between about 30 nm and about 500 nm, for example, between about 30 nm and about 200 nm. Additionally, both the silica and alumina abrasives have an average size between about 50 nanometers (nm) and about 100 nanometers (nm), of which both abrasives having an average size of about 50 nanometers (nm). It has been observed that polishing rate is adversely affected if there is a difference in size of greater than 50 nanometers (nm) between the silica and alumina abrasives.

Additionally, the relative amounts of silica and alumina abrasives in the composition can tune the desired removal rates of oxides and ruthenium removal. For example, alumina abrasives are very effective at increasing ruthenium material removal rate while decreasing oxide removal rate. Silica abrasives are very effective at removing oxide material with reduced effect on ruthenium removal.

Additionally, using different size silica and alumina abrasives, also known as mismatching, will also affect removal rate. For example, using alumina abrasives above the critical value, 50 nm, the ratio of ruthenium to oxide removal rates may be from about 2:7 to about 1:12 at a concentration of alumina from about 3 wt. % to about 8 wt. % of the composition with a constant silica concentration.

The polishing composition may also include a corrosion inhibitor for polishing a bulk metal material. A concentration of corrosion inhibitor from about 0.05 wt. % to about 0.5 wt. %, such as from about 0.15 wt. % to about 0.25 wt. %, for example, about 0.2 wt. %, of a corrosion inhibitor may be used in the barrier polishing composition. Suitable corrosion inhibitors are those described herein with regard to the first embodiment of the barrier polishing composition.

The polishing composition may also include an oxidizer. A concentration of oxidizer from about 0.05 wt. % to about 5 wt. %, such as from about 0.5 wt. % to about 2 wt. %, for example, about 1 wt. %, of the composition may be used in the polishing composition. The oxidizer may be added to the composition in a solution, such as a 30% aqueous hydrogen peroxide solution or a 40% aqueous hydrogen peroxide solution. Suitable oxidizers are those described herein with regard to the first embodiment of the barrier polishing composition.

The composition may have a pH between about 7 and about 10, such as between about 8 and about 9, for example, about 8.5.

The balance or remainder of the barrier polishing composition described above is a solvent, such as a polar solvent, including water, preferably deionized water. The solvent may be included with a component of the system, such as the oxidizer or the base composition. Other solvents may include, for example, organic solvents, such as alcohols or glycols, and in some embodiments may be combined with water. The amount of solvent may be used to control the concentrations of the various components in the barrier polishing composition. For example, the electrolyte may be concentrated up to three times as concentrated as described herein and then diluted with the solvent prior to use of diluted at the processing station as described herein.

FIGS. 4A and 4B describe a polishing process for a DRAM structure having a polysilicon material and a ruthenium barrier layer. The top portion of the DRAM structure 400 illustrates a base oxide material 410 and a barrier layer/etching mask 420 disposed thereon, such as silicon nitride, having a feature definition 415 formed therein. A first barrier layer 430, for example, titanium nitride, is deposited on the bottom and sidewalls of the feature definition to a thickness from about 10 nm to about 25 nm, a ruthenium layer 440 is deposited to a thickness from about 10 nm to about 25 nm on the barrier layer, and a polysilicon material 450 is deposited to fill the feature definition 415 as shown in FIG. 4A. The substrate surface is polished to produce the polarized structure as shown in FIG. 4B with the third barrier polishing composition described herein. The removal rate for the polysilicon, the ruthenium layer, and the titanium nitride layer was greater than 500 Å/min each with a removal rate ratio of about 1:1:1.

An example of the above polishing composition is provided as follows.

### Example #5

### For Barrier Polishing of Substrates with Polysilicon

about 94 wt. % of a B-9003 polishing composition including:
   between about 10 wt. % and about 15 wt. % of silica abrasives having an average size of 50 nm; and
   a solvent;
about 5 wt. % of alumina abrasives having an average size of 50 nm; and
about 1 wt. % hydrogen peroxide, with the composition having a pH of about 8.5.

### Example #6

### For Barrier Polishing of Substrates with Bulk Metal

about 93.8 wt. % of a B-9003 polishing composition including:
   between about 10 wt. % and about 15 wt. % of silica abrasives having an average size of 50 nm; and
   a solvent;
about 5 wt. % of alumina abrasives having an average size of 50 nm;
about 0.2 wt. % BTA; and
about 1 wt. % hydrogen peroxide, with the composition having a pH of about 8.5.

### Example #7

A substrate having polysilicon, oxide, and ruthenium barrier materials exposed thereon was transferred to a platen and a polishing composition was supplied to the platen at a rate of about 300 ml/min, and the polishing composition comprising:
about 94 wt. % of a B-9003 polishing composition including:
   between about 10 wt. % and about 15 wt. % of silica abrasives having an average size of 50 nm; and
   a solvent;
about 5 wt. % of alumina abrasives having an average size of 50 nm; and
about 1 wt. % hydrogen peroxide, with the composition having a pH of about 8.5.

The substrate was contacted with the polishing article at a contact pressure of about 2.5 psi, a platen rotational rate of about 113 rpm, a carrier head rotational rate of about 107 rpm and the respective removal rates were determined. The ruthenium barrier layer was observed to have a removal rate of about 700 Å/min, The oxide layer (TEOS deposited dielectric material) was observed to have a removal rate of about 650 Å/min, and the polysilicon layer was observed to have a removal rate of about 700 Å/min.

### The Polishing Process

Methods for chemical mechanical polishing a substrate having an exposed conductive material layer and an underlying barrier layer that may be practiced on the system 100 described above. The method may also be practiced on other chemical mechanical processing systems. The method is generally stored in the memory 112 of the controller 108, typically as a software routine. The software routine may also be stored and/or executed by a second CPU (not shown) that is remotely located from the hardware being controlled by the CPU 110.

Although embodiments described herein are discussed as being implemented as a software routine, some of the method steps that are disclosed herein may be performed in hardware as well as by the software controller. As such, the embodiments described herein may be implemented in software as executed upon a computer system, in hardware as an application specific integrated circuit or other type of hardware implementation, or a combination of software and hardware.

The method begins by positioning a substrate comprising a conductive material disposed over an underlying barrier material on a first platen containing a first polishing pad. The conductive material may comprise copper, copper alloys, or another metal, such as tungsten, and combinations thereof. The barrier layer may comprise ruthenium, ruthenium-tantalum, ruthenium nitride, ruthenium alloys, and combinations thereof. A dielectric layer may comprise an oxide, such as an oxide deposited from the chemical vapor deposition process for tetraethoxy silane (TEOS), generally underlies the barrier layer on the substrate surface.

In one embodiment of a conductive material polishing process, the substrate 122 retained in the carrier head assembly 152 is moved over the polishing pad assembly 208 disposed in the first planarization station 128. The carrier head assembly 152 is lowered toward the polishing pad assembly 208 to place the substrate 122 in contact with the top surface of the polishing pad assembly 208. The substrate 122 may be urged against the polishing pad assembly 208 with a force of less than about 2 pounds per square inch (psi). In one embodiment, the force is between about 1 psi and less than 2 psi, for example, about 1.8 psi.

Next, relative motion between the substrate 122 and polishing pad assembly 208 is provided. In one embodiment, the carrier head assembly 152 is rotated at about 30-60 revolutions per minute, while the polishing pad assembly 208 is rotated at about 7-35 revolutions per minute. The process generally has a copper removal rate of about 9000 Å/min. In one embodiment, the conductive material is a copper layer having an initial thickness between about 6000-8000 Å.

A polishing slurry is supplied to the polishing pad assembly 208. In certain embodiments, the polishing slurry also contains abrasives such as alumina or ceria. In certain embodiments, the polishing slurry may additionally comprise surfactants. Examples of suitable polishing compositions and methods for bulk chemical mechanical processes are described in U.S. patent application Ser. No. 11/839,048, entitled IMPROVED SELECTIVE CHEMISTRY FOR FIXED ABRASIVE CMP, filed Aug. 15, 2007, now published as US 2008/0182413 and U.S. patent application Ser. No. 11/356,352, entitled METHOD AND COMPOSITION FOR POLISHING A SUBSTRATE, now published as US2006/0169597, both of which are herein incorporated by reference to the extent not inconsistent with the current application. In certain embodiments, the substrate 122 contacts the polishing pad assembly 208 after addition of the polishing slurry. In certain embodiments, the substrate 122 contacts the polishing pad assembly 208 prior to the addition of the polishing slurry.

After removal of the conductive material, the barrier layer and any residual copper material are removed. In one embodiment, the barrier polish may be performed on the third planarization station 132, but may alternatively be performed one of the other planarization stations 128, 130.

The barrier processing begins by moving the substrate 122 retained in the carrier head assembly 152 over the polishing pad disposed in the second planarization station 130. The carrier head assembly 152 is lowered toward the polishing pad to place the substrate 122 in contact with the top surface of the polishing pad. The substrate 122 is urged against the polishing pad with a force less than about 3 psi, such as between 0.5 psi (3.4 kPa) and about 2.5 psi (17.3 kPa), for example, about 0.8 psi, 1.5 psi, or 2.5 psi.

Next, relative motion between the substrate 122 and polishing pad is provided. Polishing slurry as described above for barrier layer removal is supplied to the polishing pad. In one embodiment, the carrier head assembly 152 has a rotation rate from about 80 revolutions per minute (RPM) to about 100 (RPM), while the polishing pad has a rotation rate from about 90 revolutions per minute (RPM) to about 120 (RPM). The respective rotational rates of the platen and carrier head are believed to provide reduced shear forces and frictional forces when contacting the polishing article and substrate.

The barrier removal process using chemical mechanical polishing (CMP) includes providing a polishing composition at a flow rate between about 200 and about 600 milliliters per minute, such as between about 200 milliliters and about 400 milliliters per minute, for example, about 300 milliliters to the substrate surface.

The polishing pressures used herein reduce or minimize damaging shear forces and frictional forces for substrates containing low k dielectric materials. Reduced or minimized forces can result in reduced or minimal deformations and defect formation of features from polishing. Further, the lower shear forces and frictional forces have been observed to reduce or minimize formation of topographical defects, such as erosion of dielectric materials and dishing of conductive materials as well as reducing delamination, during polishing. Contact between the substrate and a conductive polishing article also allows for electrical contact between the power source and the substrate by coupling the power source to the polishing article when contacting the substrate.

After conductive material and barrier material removal processing steps, the substrate may then be buffed to minimize surface defects. Buffing may be performed with a soft polishing article, i.e., a hardness of about 40 or less on the Shore D hardness scale as described and measured by the American Society for Testing and Materials (ASTM), headquartered in Philadelphia, Pa., at reduced polishing pressures, such as about 2 psi or less.

Optionally, a cleaning composition may be applied to the substrate after each of the polishing processes to remove particulate matter and spent reagents from the polishing process as well as help minimize metal residue deposition on the polishing articles and defects formed on a substrate surface. An example of a suitable cleaning composition is ELECTRA CLEAN™, commercially available from Applied Materials, Inc., of Santa Clara, Calif.

Finally, the substrate may be exposed to a post polishing cleaning process to reduce defects formed during polishing or substrate handling. Such processes can minimize undesired oxidation or other defects in copper features formed on a substrate surface. An example of such a post polishing cleaning is the application of ELECTRA CLEAN™, commercially available from Applied Materials, Inc., of Santa Clara, Calif.

It has been observed that substrate planarized by the processes described herein have exhibited reduced topographical defects, such as dishing and erosion, reduced residues, improved planarity, and improved substrate finish.

While the foregoing is directed to embodiments of the present invention, other and further embodiments of the invention may be devised without departing from the basic scope thereof, and the scope thereof is determined by the claims that follow.

1. A composition for removing at least a barrier material from a substrate surface, comprising:
a metal base polishing composition having at least a solvent and from about 10 wt. % to about 15 wt. % of silica abrasive;
from about 0.05 wt. % to about 0.5 wt. % of a metal passivating compound; and
from about 0.05 wt. % to about 5 wt. % of an oxidizer, wherein the composition has a pH from about 7 to about 10.

2. The composition of claim 1, wherein the metal passivating agent comprises a corrosion inhibitor having one or more azole groups selected from the group consisting of benzotriazole (BTA), mercaptobenzotriazole, 5-methyl-1-benzotriazole (TTA), 1,2,4 Triazole (TRZ), and combinations thereof, and the oxidizer comprises a compound selected from the group of hydrogen peroxide, urea hydrogen peroxide, benzoyl peroxide, peracetic acid, ditertbutyl peroxide, ammonium peroxydisulfate, potassium peroxydisulfate, ammonium persulfate, and potassium persulfate, and combinations thereof.

3. The composition of claim 1, further comprising an alumina abrasive at a ratio of silica abrasive to alumina abrasive from about 15:1 to about 2:1.

4. The composition of claim 3, wherein the alumina abrasive comprises from about 1 wt. % to about 5 wt. % of the composition.

5. The composition of claim 3, wherein the silica abrasive and the alumina abrasive each have an average size from 50 micron to 100 micron.

6. A method for processing a substrate, comprising:
disposing a substrate having patterned feature definitions, a ruthenium-based barrier layer disposed in the patterned feature definitions, and a metal layer disposed on the barrier layer and substrate surface in a polishing apparatus;
polishing the metal layer to expose the barrier layer; and
polishing the ruthenium-based barrier layer using a composition comprising:
a metal base-polishing composition having at least a solvent and from about 10 wt. % to about 15 wt. % of silica abrasive;
from about 0.05 wt. % to about 0.5 wt. % of a metal passivating compound; and
from about 0.05 wt. % to about 5 wt. % of an oxidizer, wherein the composition has a pH from about 7 to about 10.

7. The method of claim 6, wherein the ratio of removal rate of ruthenium-based barrier layer to the removal rate of metal is about 1.75:1.

8. The method of claim 6, wherein the polishing the ruthenium-based barrier layer barrier layer comprises a downforce polishing pressure from about 0.8 to about 1.5 psi.

9. The method of claim 6, wherein the ruthenium-based barrier layer comprises ruthenium or a ruthenium-tantalum alloy.

10. The method of claim 6, wherein the metal passivating agent comprises a corrosion inhibitor having one or more azole groups selected from the group consisting of benzotriazole (BTA), mercaptobenzotriazole, 5-methyl-1-benzotriazole (TTA), 1,2,4 Triazole (TRZ), and combinations thereof, and the oxidizer comprises a compound selected from the group of hydrogen peroxide, urea hydrogen peroxide, benzoyl peroxide, peracetic acid, ditertbutyl peroxide, ammonium peroxydisulfate, potassium peroxydisulfate, ammonium persulfate, and potassium persulfate, and combinations thereof.

11. The method of claim 6, further comprising an alumina abrasive at a ratio of silica abrasive to alumina abrasive from about 15:1 to about 2:1.

12. The method of claim 11, wherein the alumina abrasive comprises from about 1 wt. % to about 5 wt. % of the composition.

13. The method of claim 11, wherein the silica abrasive and the alumina abrasive each have a size from 50 micron to 100 micron.

14. The method of claim 11, wherein the polishing the ruthenium-based barrier layer and dielectric layer comprises a ratio of removal rate of ruthenium-based barrier layer to dielectric material from about 1:4 to about 1:2 and a ratio of removal rate of ruthenium-based barrier layer to metal layer from about 4:1 to about 1:1.

15. The method of claim 11, wherein the dielectric material comprises a silicon oxide material deposited from a tetra ethyloxy silane precursor and the metal layer comprises copper.

16. A method for processing a substrate, comprising:
disposing a substrate having patterned feature definitions formed in a dielectric material, a ruthenium-based barrier layer disposed in the patterned feature definitions, and a polysilicon layer disposed on the barrier layer and substrate surface in a polishing apparatus; and
non-selective polishing the polysilicon layer, the ruthenium-based barrier layer and dielectric layer using a composition comprising:
a conductive material base polishing composition having at least a solvent and from about 10 wt. % to about 15 wt. % of silica abrasive;
from about 1 wt. % to about 8 wt. % of an alumina abrasive; and
from about 0.05 wt. % to about 5 wt. % of an oxidizer, wherein the composition has a pH from about 7 to about 10.

17. The method of claim 16, wherein the polishing the ruthenium-based barrier layer and dielectric layer comprises polishing at a downforce pressure from 0.5 psi to 5 psi.

18. The method of claim 16, wherein the non-selective polishing the polysilicon layer, the ruthenium-based barrier layer, and the dielectric layer comprises a ratio of removal rate of polysilicon layer to ruthenium-based barrier layer to dielectric layer of about 1:1:1.

19. The method of claim 17, wherein the dielectric material comprises a silicon oxide material deposited from a tetra ethyloxy silane precursor, the ruthenium-based barrier layer comprises ruthenium or a ruthenium-tantalum alloy.

20. The method of claim 17, wherein the silica abrasive and the alumina abrasive each have a size from 50 micron to 100 micron.
